(19) United States
(12) Patent Application Publication
(10) Pub. No.: US 2020/0335125 A1
(43) Pub. Date: Oct. 22, 2020

(54) DETECTION OF AUDIO ANOMALIES

(71) Applicant: Raytheon Company, Waltham, MA (US)

(72) Inventors: David W. Palmer, Fort Wayne, IN (US); Justin Hagan, Fort Wayne, IN (US)

(73) Assignee: Raytheon Company, Waltham, MA (US)

(21) Appl. No.: 16/388,903

(22) Filed: Apr. 19, 2019

(51) Int. Cl. G10L 25/51; G10L 15/08

(52) U.S. Cl. CPC G10L 25/51; G10L 2015/088; G10L 15/08

(57) ABSTRACT

Methods and apparatus for detecting audio anomalies from a reference audio file and a sampled audio filed. In embodiments, a system can perform aligning in time first and second audio files, dividing the first and second audio files into chunks, performing time-based processing of the amplitude adjusted output of the first and second audio files to identify audio anomalies in the second audio file, and performing frequency-based processing of the amplitude adjusted output of the first and second audio files to identify audio anomalies in the second audio file.

### STATEMENT REGARDING FEDERALLY SPONSORED RESEARCH

This invention was made with government support under government contract W15P7T-06-D-A008 awarded by the US Army. The government has certain rights in the invention.

### BACKGROUND

Conventional radio integration and qualification activities involving the use of audio, such as voice, require tens of thousands of hours over the course of a radio product lifecycle. This is due to the lack of reliable equipment that can detect anomalies in audio so that costly manual testing is needed. This is labor intensive and time-consuming and is also subject to the opinion and hearing ability of the tester. Furthermore, even when using a human tester, audio anomalies are not easily captured.

Some prior attempts have been made to detect audio anomalies using commercially available test equipment, such as an audio analyzer. However, audio analyzers typically only give an overall score to an injected tone. Tones, by themselves, are deficient as test data for vocoders and do not identify individual word failures. Some audio analyzers, such as KEYSIGHT U8903B, provide the ability for actual audio with multiple channels using PESQ (Perceptual Evaluation of Speech Quality). PESQ uses a known reference sample and compares it to captured sample under test and gives it a score of 1 (bad) to 5 (excellent). However, such systems are subjective and time-consuming.

### SUMMARY

Methods and apparatus of the invention provide detection and classification of audio anomalies using a reference audio sample and a subject audio sample. In embodiments, the subject audio sample is time-aligned with the reference audio sample. The time-aligned samples are divided into number of chunks. For example, a voice signal is divided into words, or groups of words. A time-domain scoring process and a frequency-domain scoring process are applied independently to the time-aligned chunks, e.g., words. The outputs of the time-based and frequency-based scoring processes may include scores for classifying detected anomalies. The detected anomalies can be used to address design and/or operational issues in a radio.

In one aspect, a method comprises: aligning in time first and second audio files; dividing the first audio file into chunks; dividing the second audio files into chunks that correspond to the chunks of the first audio file; adjusting an amplitude of one of both of the chunks of the first audio file and the second audio file and generating an amplitude adjusted output of the first and second audio files; performing time-based processing of the amplitude adjusted output of the first and second audio files to identify audio anomalies in the second audio file; and performing to frequency-based processing of the amplitude adjusted output of the first and second audio files to identify audio anomalies in the second audio file.

A method can further include one or more of the following features: the chunks of the first audio file comprise extracted words, the chunks of the first audio file comprise extracted sentences, the chunks of the first audio file comprise extracted syllables, the time-based processing comprises distance processing between the amplitude adjusted output of the first and second audio files, generating a time-based processing score, the frequency-based processing comprises spectral power processing of the amplitude adjusted output of the first and second audio files, generating a frequency based processing score, the identified audio anomalies comprise missed words in the second audio file, the identified audio anomalies comprise distorted words, the time-based processing comprises distance processing between the amplitude adjusted output of the first and second audio files and generating a time-based processing score, and/or the frequency-based processing comprises spectral power processing of the amplitude adjusted output of the first and second audio files and generating a frequency based processing score, and further including using the time-based processing score and/or the frequency based processing score to classify ones of the identified audio anomalies.

In another aspect, a system comprises: a time alignment module to align in time first and second audio files; an extraction module to divide the first audio file into chunks and to divide the second audio files into chunks that correspond to the chunks of the first audio file; an amplitude correction module to adjust an amplitude of one of both of the chunks of the first audio file and the second audio file and generate an amplitude adjusted output of the first and second audio files; a time-based processing module to perform time-based processing of the amplitude adjusted output of the first and second audio files to identify audio anomalies in the second audio file; and a frequency-based processing module to perform frequency-based processing of the amplitude adjusted output of the first and second audio files to identify audio anomalies in the second audio file.

A system can further include one or more of the following features: the chunks of the first audio file comprise extracted words, the chunks of the first audio file comprise extracted sentences, the chunks of the first audio file comprise extracted syllables, the time-based processing comprises distance processing between the amplitude adjusted output of the first and second audio files, the frequency-based processing comprises spectral power processing of the amplitude adjusted output of the first and second audio files, and/or the time-based processing comprises distance processing between the amplitude adjusted output of the first and second audio files and generating a time-based processing score, and wherein the frequency-based processing comprises spectral power processing of the amplitude adjusted output of the first and second audio files and generating a frequency based processing score, and further including using the time-based processing score and/or the frequency based processing score to classify ones of the identified audio anomalies.

In a further aspect, a system comprises: a time alignment means for aligning in time first and second audio files; an extraction means for dividing the first audio file into chunks and to divide the second audio files into chunks that correspond to the chunks of the first audio file; an amplitude correction means for adjusting an amplitude of one of both of the chunks of the first audio file and the second audio file and generate an amplitude adjusted output of the first and second audio files; a time-based processing means for performing time-based processing of the amplitude adjusted output of the first and second audio files to identify audio anomalies in the second audio file; and a frequency-based processing means for performing frequency-based processing of the amplitude adjusted output of the first and second audio files to identify audio anomalies in the second audio file.

### BRIEF DESCRIPTION OF THE DRAWINGS

The foregoing features of this invention, as well as the invention itself, may be more fully understood from the following description of the drawings in which:

FIG. 1 is a block diagram of an example radio system having reference audio and sampled audio for audio anomaly detection;

FIG. 2 is a block diagram of an example system for processing reference and sampled audio;

FIG. 3 is a schematic representation of an example system having time-based and frequency-based processing for detecting audio anomalies;

FIG. 4A shows example waveforms without audio anomalies;

FIG. 4B shows example waveforms with audio anomalies;

FIG. 5 is a flow diagram showing an example sequence of steps for detecting audio anomalies;

FIG. 6 is a flow diagram showing an example sequence of steps for performing time-based and frequency-based audio anomaly detection;

FIG. 7 is flow diagram showing an example sequence of steps for processing detected anomalies; and

FIG. 8 is a schematic representation of an example computer that can perform at least a portion of the processing described herein.

### DETAILED DESCRIPTION

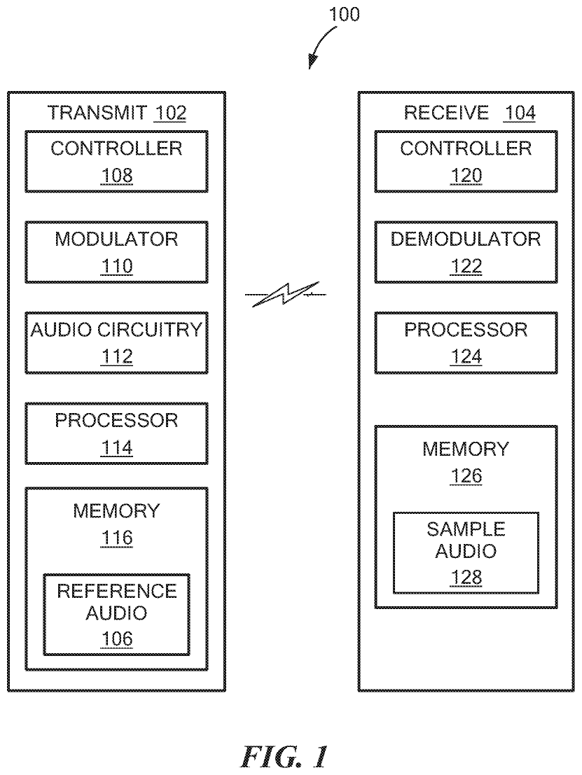

FIG. 1 shows an example system 100 for detecting audio anomalies in accordance with example embodiments of the invention. In embodiments, the system 100 is directed to detecting anomalies for a radio in which signals are transmitted by a transmitter 102 and received by a receiver 104. It is understood that in a bi-directional system, transceivers can be used instead of, or in addition to, transmitter and receivers. The signal transmitted by the transmitter 102 can be stored as reference audio 106.

The transmitter 102 can include a controller 108 for controlling overall operation of the transmitter/radio and a modulator 110 can encode data for transmission in manner well-known in the art. The transmitter 102 can include circuitry 112, such as amplifiers, to process the signal for transmission. A processor 114 and memory 116 can be provided to execute stored instructions and can store the reference audio 106. In embodiments, reference audio refers to digital data prior to modulation. Reference audio can be any voice signal or arbitrary signal that is supported by the computer's digitizing mechanism (e.g. a sound card in a computer). The classification process is independent of the radio or modulation type.

The receiver 104 can include a controller 120 for controlling overall operation and a demodulator 122 for demodulating the signal received from the transmitter 102. A processor 124 and memory 126 can be provided to execute stored instructions and can store sampled audio 128. The reference audio 106 and sampled audio 128 can be processed to detect audio anomalies, as described more fully below. In embodiments, the system under test is treated as a black box with the transmit system having a transmit signal input and the receive system having a receive system output.

In embodiments, an example system to detect audio anomalies is useful to confirm operational requirements for a prototype system. For example, audio signals having speech can be divided into words and/or sentences. The reference audio and sampled audio can be time-aligned and processed to identify an audio anomaly in the form of missing words. This type of anomaly can be due to a coding error in the design phase, for example. Circuit-based anomalies can be detected that are due to design issues, such as insufficient headroom for audio signals. In other embodiments, a system to detect audio anomalies is useful to detect intermittent audio anomalies in field equipment. For example, intermittent audio anomalies that are associated with one particular frequency or narrow frequency band may be challenging to locate. The system can record data for hours or weeks, for example, to facilitate the detection and/or classification of an audio anomaly associated with a particular frequency.

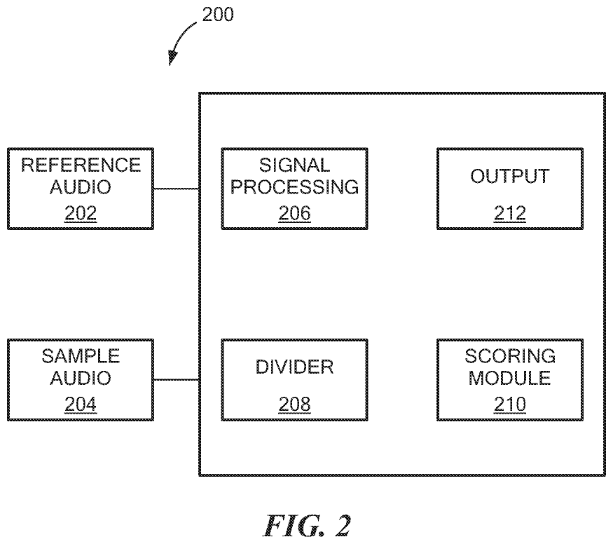

FIG. 2 is a high level block diagram of an audio anomaly detection system 200 for processing a reference audio 202 and a sampled audio 204. In embodiments, a signal processing module 206 receives the reference and sampled audio 202, 204 and a divider 208 divides the audio into blocks based on one or more selected criteria. In embodiments, the blocks in the reference and sampled audio correspond to each other to enable block-block processing. In an ideal system, the reference and sampled audio data would be substantially similar in the absence of anomalies. In one embodiment, the signal processing module extracts words in the audio that can be processed using the reference and sample audio by a scoring module 210 that generates scores for blocks of audio, as described more fully below. An output module 212 can store and output scoring information for further processing/analysis.

It is understood that the reference and sample audio can be broken into chunks based on any suitable criteria or combination of criteria, such as time period, sentences, frequency characteristics, envelope characteristics, and the like. In embodiments, the chunks or blocks of the reference audio and the sample audio can be aligned in time prior to anomaly processing. Time alignment can be performed by cross correlation in the time domain between the reference signal and the sample signal. It is understood that any practical technique can be used for signal time alignment.

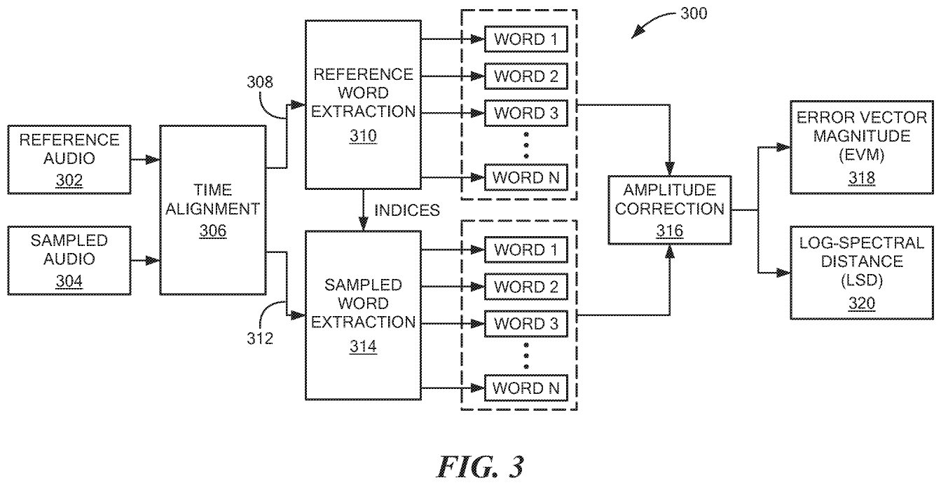

FIG. 3 shows an example audio anomaly detection system 300 that is based on word extraction with time-based and frequency-based audio distortion processing. A reference audio 302 and a sampled audio 304 are provided to a time alignment module 306. In embodiments, the time alignment module 306 aligns the reference audio 302 and sample audio 304 using cross-correlation, for example. It is understood that any suitable time alignment technique can be used to meet the requirements of a particular application. Lag correction can be also be performed on the audio.

The time-aligned reference audio 308 is provided to a reference audio word extraction module 310 and the time-aligned sample audio 312 is provided to a sample audio word extraction module 314. Words can be extracted from the respective reference and sample audio using any suitable speech recognition technique known to one skilled in the art. In an example embodiment, hardcoded indices and/or envelope detection is used by the reference audio word extraction module 310 which generates indexes that can be used by the sampled word extraction module 314.

The reference audio word extraction module 310 generates a series of words from the audio shown as word 1, word 2, word 3, . . . word n. Similarly, the sample audio word extraction module 314 generates time aligned corresponding words. The reference words and sample words are provided to an amplitude correction module 316 for equalization, for example. If the reference and sample words are not equalized in magnitude then frequency-based spectral power processing, for example, may not be accurate.

In embodiments, the output of the amplitude correction module 316 is provided to first and second audio anomaly detection modules 318, 320. In embodiments, the first anomaly detection module 318 comprises time-based processing and the second anomaly detection module 320 comprises frequency-based processing. The outputs of the time-based and frequency-based processing can be used to identify audio anomalies and optionally classify the detected anomaly.

In one embodiment, the first anomaly detection module 318 comprises processing the extracted words to detect distortion in the audio signal using a distance measure, such as error vector magnitude (EVM) processing. In one particular embodiment, EVM, which uses Euclidian distance, can be performed as:

$$EVM = 100 \% \times \sqrt{\frac{{\sum }_{k = 1}^{N} {\vert {y}_{k} - {x}_{k} \vert}^{2}}{{\sum }_{k = 1}^{N} {\vert {x}_{k} \vert}^{2}}} ,$$

where x is the reference audio signal, y is the sample audio signal, and N is the number of samples in x and y.

It is understood that any suitable audio distortion processing technique, such as Euclidian, Chebyshev, Minkowski and other distance measuring techniques, can be used to meet the needs of a particular application.

In an embodiment, the second anomaly detection module 320 comprises processing the extracted words detecting distortion in the audio signal using log-spectral distance (LSD) processing. In embodiments, the signal is converted to frequency using FFT processing, for example, over a given frequency band divided into a suitable number of frequency bins. In one embodiment, LSD processing can be performed as:

$$LSD = {\sum }_{k = 1}^{N} {[ 10 {log}_{10} \frac{{P}_{r} ( k )}{P ( k )} ]}^{2} ,$$

where Pᵣ is the power spectra of the reference signal, P is the power of the sampled signal, and N is the number of frequency bins used to compute the power spectra Pᵣ and P.

It is understood that any suitable spectral power processing technique such as Power Spectral Density, Energy Spectral Density, Cross-Power Spectral Density, etc., can be used to define an amount of signal distortion between the reference signal and the sample signal.

In embodiments, the processed words can be scored by the first and second anomaly detection modules 318, 320. Based on the scores of one and/or both of the first and second anomaly detection modules 318, 320, a word, or other processed chunk of audio signal, can be flagged as having a potential anomaly, as described more fully below.

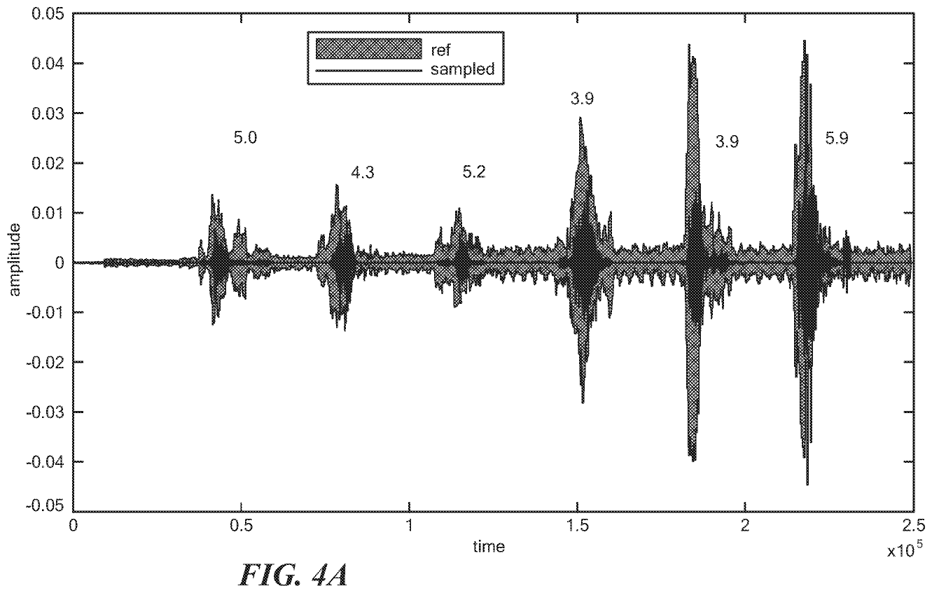

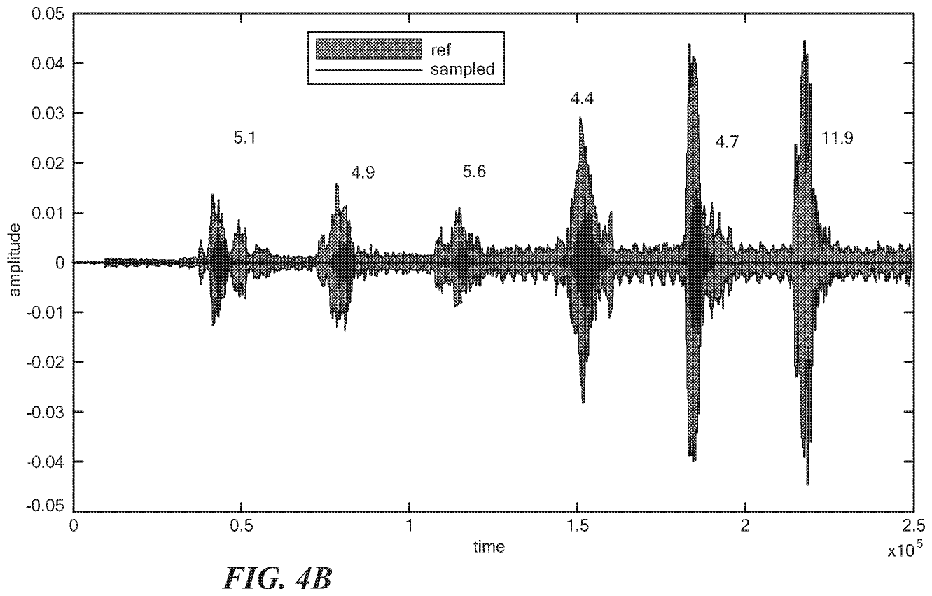

FIG. 4A shows a ‘clean’ plot of time versus amplitude with example scores for illustrative LSD processing of reference audio 400 and sampled audio 402. As used in the context of this plot, clean refers to no skipped words or other audio anomalies. In this example, MELP (Mixed-Excitation Linear Prediction) voice encoding is used. As can be seen, the greater the power spectra match between the reference audio 400 and the sampled audio 402, the lower the score. Similarly, the less of a spectra match between the signals the higher the score. The lowest score shown is 3.9 and the highest score shown in 5.0, none of which are indicative of an audio anomaly.

FIG. 4B shows a plot of time versus amplitude with example scores for illustrative LSD processing of reference audio 400 and sampled audio 402 using MELP encoding. As can be seen, the plot has a word scored as 11.9 corresponding to an audio anomaly in the form of a skipped word in the sampled audio 402.

In embodiments, the detected anomalies can be classified according to the type of the anomaly. For example, skipping of the first and/or last word in the sample audio can be classified as audio anomalies indicative of a coding error. Distortion in a narrow frequency may be classified as a circuit failure, such as an amplifier malfunction. For example, missed blocks at the beginning can indicate a timing issue with tasking. Missed blocks in the middle can indicate processor and priority issues with threads. Excessive distortion can indicate compression of the analog hardware. Missed blocks at the end can indicate timing issues, queue sizes not being correct, etc.

It will be appreciated that processing the reference and sample audio to identify audio anomalies can be used to exercise a prototype system to find coding errors, hardware design flaws, circuit component failures, and the like. In addition, an anomaly detection system can also be used to confirm that operational and design requirements have been met by enabling a radio to be comprehensively exercised using reference and sampled data.

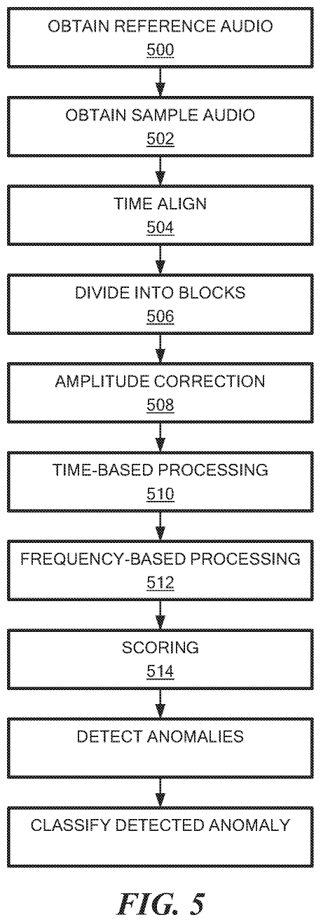

FIG. 5 shows an example sequence of steps for providing audio anomaly detection in accordance with example embodiments of the invention. In step 500, a reference audio signal is provided. In step 502, a sampled audio signal is provided. In step 504, the reference and sampled audio signals are aligned in time. In step 506, the time-aligned reference signal is broken into blocks or chunks, such as extracted words, and the time-aligned sampled signal is broken in into corresponding chunks.

In step 508, the amplitudes of the reference audio chunks and the sampled audio chunks are processed, such as equalized to have the same amplitudes. In step 510, time-based processing is performed on the reference and sampled audio chunks to identify audio anomalies. In embodiments, speech distortion distance techniques are used to generate scores from the reference and sample chunks, e.g., extracted words. In step 512, frequency-based processing is performed on the reference and sampled audio chunks to identify audio anomalies. In embodiments, power spectral processing techniques are used to generate scores from the reference and sample chunks. In step 514, the time-based and frequency-based scores are processed to identify anomalies in step 516. In optional step 518, the detected anomalies can be classified, as described more fully below.

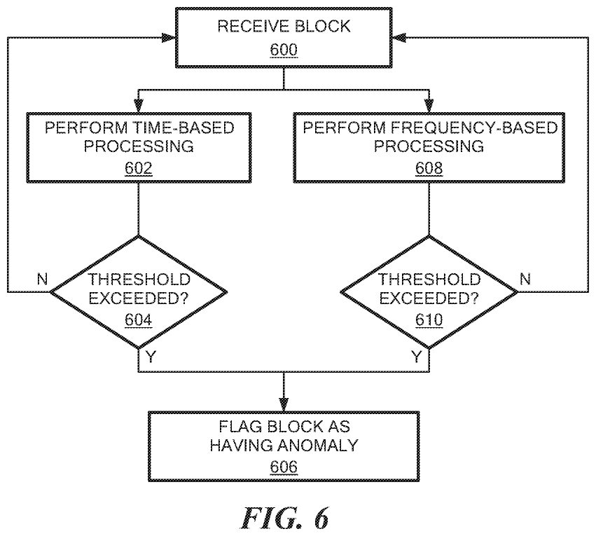

FIG. 6 shows an example sequence of steps for processing the time-based and frequency-based scores to detect an anomaly. In step 600, a first block, such as a word, is processed. In step 602, the time-based processing score is generated and in step 604 the score is compared against a first threshold. If the time-based score is above the first threshold, the first block is flagged as having an anomaly in step 606. In step 608, which can be performed in series or parallel with step 602, frequency-based processing is performed and in step 610 the score is compared against a second threshold for a frequency-based score. If the frequency-based score is above the second threshold, the first block is flagged as having an anomaly in step 606. It is understood that time and frequency processing can be performed in any order and in series or parallel.

In other embodiments, a given block is flagged as having an anomaly when the scores for the time-based processing and the frequency-based processing are both above respective thresholds. In other embodiments, a first one of the time or frequency-based processing is used as the primary detection method while the other one is used as secondary detection method to confirm detection by the primary method. That is, if the primary detection method does not exceed a threshold, then the next block is tested regardless of the secondary detection method, which may or may not be performed.

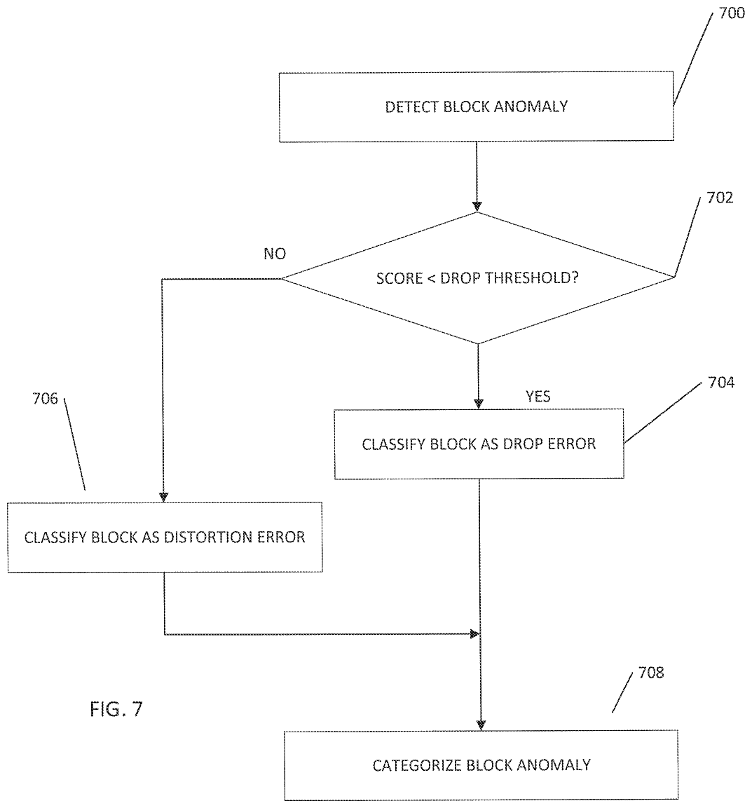

FIG. 7 shows an example sequence of steps for processing a detected anomaly to classify the anomaly. In embodiments, detected anomalies include missed words, distorted words, and the like. In step 700, an anomaly in one or more blocks is detected, such as the block being flagged as having an anomaly in step 606 of FIG. 6. In step 702, one or more of the scores (see FIG. 6) is compared against a drop threshold. If the score is less than the drop threshold, in step 704 the block having the anomaly is classified as being a drop error. If the score is greater than the drop threshold, the block is classified as being a distortion error in step 706. Processing then continues in step 708 to categorize the block anomalies. Example categories for anomalies include partial distortion, complete distortion, intermittent drops, drop at the beginning, drop in the middle, drop at the end, complete drop, mixed distortion and drop. It is understood that any number of categories can be used to meet the needs of a particular application.

Upon the classification of the bloc(s) k having the anomaly, an engineering team can review the results and review the likely causes of the issue. After investigation via test, debugging, analysis, and the like, the source of the anomaly can be determined and addressed.

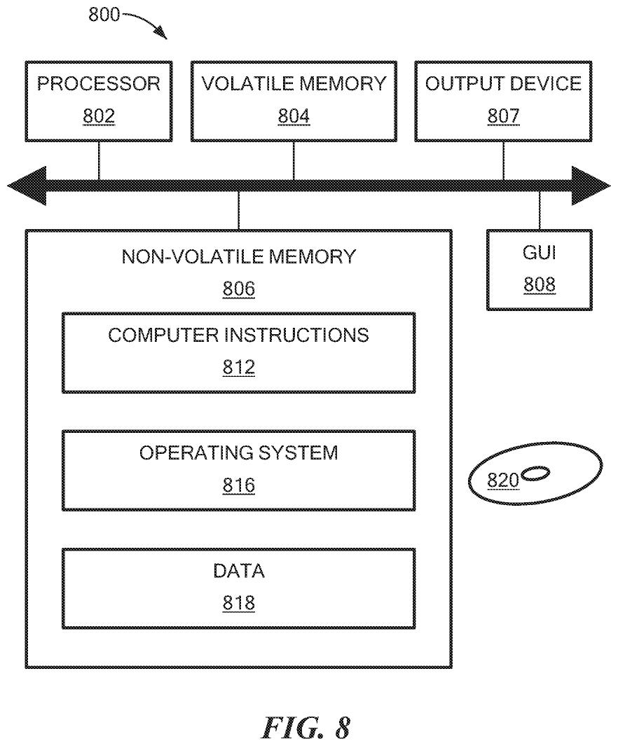

FIG. 8 shows an exemplary computer 800 that can perform at least part of the processing described herein, such as the processing of FIGS. 5, 6, and/or 7. The computer 800 includes a processor 802, a volatile memory 804, a non-volatile memory 806 (e.g., hard disk), an output device 807 and a graphical user interface (GUI) 808 (e.g., a mouse, a keyboard, a display, for example). The non-volatile memory 806 stores computer instructions 812, an operating system 816 and data 818. In one example, the computer instructions 812 are executed by the processor 802 out of volatile memory 804. In one embodiment, an article 820 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method, comprising:
aligning in time first and second audio files;
dividing the first audio file into chunks;
dividing the second audio files into chunks that correspond to the chunks of the first audio file;
adjusting an amplitude of one of both of the chunks of the first audio file and the second audio file and generating an amplitude adjusted output of the first and second audio files;
performing time-based processing of the amplitude adjusted output of the first and second audio files to identify audio anomalies in the second audio file; and
performing frequency-based processing of the amplitude adjusted output of the first and second audio files to identify audio anomalies in the second audio file.

2. The method according to claim 1, wherein the chunks of the first audio file comprise extracted words.

3. The method according to claim 1, wherein the chunks of the first audio file comprise extracted sentences.

4. The method according to claim 1, wherein the chunks of the first audio file comprise extracted syllables.

5. The method according to claim 1, wherein the time-based processing comprises distance processing between the amplitude adjusted output of the first and second audio files.

6. The method according to claim 5, further including generating a time-based processing score.

7. The method according to claim 1, wherein the frequency-based processing comprises spectral power processing of the amplitude adjusted output of the first and second audio files.

8. The method according to claim 7, further including generating a frequency based processing score.

9. The method according to claim 1, wherein the identified audio anomalies comprise missed words in the second audio file.

10. The method according to claim 1, wherein the identified audio anomalies comprise distorted words.

11. The method according to claim 1, wherein the time-based processing comprises distance processing between the amplitude adjusted output of the first and second audio files and generating a time-based processing score, and wherein the frequency-based processing comprises spectral power processing of the amplitude adjusted output of the first and second audio files and generating a frequency based processing score, and further including using the time-based processing score and/or the frequency based processing score to classify ones of the identified audio anomalies.

12. A system comprising:
a time alignment module to align in time first and second audio files;
an extraction module to divide the first audio file into chunks and to divide the second audio files into chunks that correspond to the chunks of the first audio file;
an amplitude correction module to adjust an amplitude of one of both of the chunks of the first audio file and the second audio file and generate an amplitude adjusted output of the first and second audio files;
a time-based processing module to perform time-based processing of the amplitude adjusted output of the first and second audio files to identify audio anomalies in the second audio file; and
a frequency-based processing module to perform frequency-based processing of the amplitude adjusted output of the first and second audio files to identify audio anomalies in the second audio file.

13. The system according to claim 12, wherein the chunks of the first audio file comprise extracted words.

14. The system according to claim 12, wherein the chunks of the first audio file comprise extracted sentences.

15. The system according to claim 12, wherein the chunks of the first audio file comprise extracted syllables.

16. The system according to claim 12, wherein the time-based processing comprises distance processing between the amplitude adjusted output of the first and second audio files.

17. The system according to claim 12, wherein the frequency-based processing comprises spectral power processing of the amplitude adjusted output of the first and second audio files.

18. The system according to claim 12, wherein the time-based processing comprises distance processing between the amplitude adjusted output of the first and second audio files and generating a time-based processing score, and wherein the frequency-based processing comprises spectral power processing of the amplitude adjusted output of the first and second audio files and generating a frequency based processing score, and further including using the time-based processing score and/or the frequency based processing score to classify ones of the identified audio anomalies.

19. A system comprising:
a time alignment means for aligning in time first and second audio files;
an extraction means for dividing the first audio file into chunks and to divide the second audio files into chunks that correspond to the chunks of the first audio file;
an amplitude correction means for adjusting an amplitude of one of both of the chunks of the first audio file and the second audio file and generate an amplitude adjusted output of the first and second audio files;
a time-based processing means for performing time-based processing of the amplitude adjusted output of the first and second audio files to identify audio anomalies in the second audio file; and
a frequency-based processing means for performing frequency-based processing of the amplitude adjusted output of the first and second audio files to identify audio anomalies in the second audio file.
